(19) United States
(12) Patent Application Publication
(10) Pub. No.: US 2006/0206704 A1
(43) Pub. Date: Sep. 14, 2006

(54) Data transmission system and method for operating a data transmission system

(75) Inventors: Alexander Gauby, Graz (AT); Berthold Haberler, Linz (AT)

Correspondence Address: DARBY & DARBY P.C., P. O. BOX 5257, NEW YORK, NY, 10150-5257, US

(73) Assignee: RF-IT Solutions GmbH, Graz (AT)

(21) Appl. No.: 11/364,819

(22) Filed: Feb. 27, 2006

Related U.S. Application Data
(63) Continuation of application No. PCT/DE04/01880, filed on Aug. 25, 2004.

(30) Foreign Application Priority Data
Aug. 26, 2003 (DE) 103 39 212.2

(51) Int. Cl. H04L 9/00

(52) U.S. Cl. 713/150

(57) ABSTRACT

A data transmission system includes a data storage medium that has a segmented memory that stores an application directory that has an attribute for identifying an application area of the data storage medium and has a logical application number which is associated with an executable application and which is determinately specified by the attribute. The logical application number is used as an index within the application directory. The data transmission system further includes a read/write unit that stores the attribute and the logical application number of the application. The read/write unit is configured to execute the application by using the logical application number in the application directory for indexing and finding a start address for a sector of the memory which stores the executable application.

### CROSS REFERENCE TO RELATED APPLICATIONS

The present application is a continuation of International Patent Application Serial No. PCT/DE2004/001880, filed Aug. 25, 2004, published in the German language, which claims priority to German Patent Application Serial No. 10339212.2, filed Aug. 26, 2003, both of which are hereby expressly incorporated by reference in their entireties.

### TECHNICAL FIELD

The present invention relates to a data transmission system and to a method for operating a data transmission system.

### BACKGROUND

Data transmission systems, particularly transmission systems using “contactless chip cards”, allow data interchange between a data storage medium and a usually stationary read/write unit with the aim of identifying the cardholder, for example, for making a cashless payment or the like.

One of the fundamental advantages of such a data transmission system is the wide variety of use options for the cardholder. The memory means integrated in the data storage medium allow particular applications to be stored, which can include a plurality of functions or parameters, for example for checking security. The memory of a data storage medium is split, on the basis of the prior art, into sectors constructed from individual rows. The number of rows is chosen on the basis of the size of the application. To protect highly sensitive data, the memory of the data storage medium stores a plurality of keys which are associated with a sector, belonging to an application, and which provide authorization only for reading, for reading and writing data or for debiting or for crediting and debiting values, for example.

To access the executable applications stored on the data storage medium, the data transmission system normally has knowledge of statically stipulated start addresses for the sector associated with the individual application so that each application has an associated firm start address within the memory. However, if a specific application area of the data storage medium has no provision for execution of an application, the data segment or the sector provided for this application remains unused. Hence, although the memory space is not occupied by data, it is not possible to allocate it to a further application, since it needs to remain in a reserved status. Another drawback is the use of a table which is stored in the memory and which associates start addresses for the sectors with identification numbers for the applications. To ensure that the identification numbers are determinate, they need to have a particular number of bits. In addition, the result of looking for a start address for an application is that the entire table needs to be searched, which disadvantageously increases the data processing time.

### SUMMARY

It is therefore an object of the invention to configure a data processing system such that the data processing time is significantly shortened and the utilization of the memory is optimized. Another object is to specify a method for operating a data processing system for this.

The above object is achieved by a data transmission system according to the present invention. The data transmission system is configured to execute applications which are independent of one another and which are reciprocally protected by secret keys.

The data transmission system includes a data storage medium that has a segmented memory that stores an application directory that has an attribute for identifying an application area of the data storage medium and has a logical application number which is associated with an executable application and which is determinately specified by the attribute. The logical application number is used as an index within the application directory.

The data transmission system further includes a read/write unit that stores the attribute and the logical application number of the application. The read/write unit is configured to execute the application by using the logical application number in the application directory for indexing and finding a start address for a sector of the memory which stores the executable application.

Further aspects and features of the exemplary in-situ vision gauge disclosed herein can be appreciated from the appended Figures and accompanying written description.

### BRIEF DESCRIPTION OF THE DRAWING FIGURES

The invention is explained in more detail below using exemplary embodiments with reference to the figures. Identical or corresponding elements in different figures have been provided with the same reference symbols.

FIG. 1 shows a block diagram of the memory organization of a memory of a data storage medium in a data transmission system based on the invention;

FIG. 2 shows a detailed exemplary embodiment of an application directory;

FIG. 3 shows an exemplary embodiment of a table stored in the memory of the read/write unit; and

FIGS. 4a to 4c show a detailed illustration of the memory's memory organization shown in FIG. 1.

### DETAILED DESCRIPTION OF THE PRESENT INVENTION

According to one aspect of the present invention, a data transmission system is configured such that a memory associated therewith stores an application directory that has an attribute for identifying an application area of the data storage medium and has a logical application number associated with an executable application. The logical application number is used as an index within the application directory. The system further includes a read/write unit that has knowledge of the attribute and the logical application number of the application, and the read/write unit is configured to execute the application by using the logical application number in the application directory for indexing and finding a start address for a sector of the memory which stores the executable application.

The present invention further achieves the above object for the method in that the read/write unit in the present data transmission system evaluates the attribute, prior to execution of the application, in order to establish whether the application area associated with the data storage medium has provision for execution of the application. If the result of the evaluation is positive, the system uses a logical application number, corresponding to the executable application, in the application directory as an index in order to read a start address for a sector of the memory which stores the executable application.

The application directory includes a table of start addresses for sectors which can have an associated application. In order to access an application, the exact table entry in the application directory can be read immediately on the basis of the logical application number known to the read/write unit without reading the entire directory. In the next step, the application's associated sector's start address associated with the logical application number is used in order to execute the application.

In one advantageous embodiment, the start address of the application is encoded in a sector by the respective memory position of the logical application number within the application directory. The arrangement of the applications within the memory or the association with a sector can therefore be handled independently and entirely flexibly.

Advantageously, by way of example, an application A with a logical application number “1” can be erased at any time, so that the memory space or this sector A1 which has become free is available for a programmable new application B. By way of example, the data transmission system knows the logical application number “2” for the new application B, said application number being written to the memory position for the logical application number “2” in the application directory. Independently of this, the application B can be allocated the former start address of the sector A1. In addition, the entry of the logical application number “1” is used to indicate that the application A is now no longer in the memory of the data storage medium.

The attribute for identifying the application area of the data storage medium is advantageously used to establish whether the present data storage medium associated with an application area has provision for execution of a particular application. The attribute occupies the first bits of the application directory and is able to be divided into two parts, with one part, for example, the less significant bits, being used to specify the data storage medium and a further part, for example, the more significant bits, being used to indicate the application area. Admissible executable applications are freely definable for each application area.

It is particularly advantageous that the logical application number has not only an associated start address for the sector but also an associated key number. The read/write unit reads the key number for the sector protected by a key against unauthorized access and accesses a table which is stored in the memory of the read/write unit and in which the key number has an associated physical memory address in the memory in the data storage medium for the key required for accessing the sector.

In another advantageous embodiment, the number of executable applications is limited by the number of logical application numbers shown in the application directory. Specific logical application numbers known to the data transmission system can be used to indicate start addresses for the next available sector for programming a new application or currently unused sectors but ones which were formerly already associated with an application or to refer to a further application directory stored in the data storage medium. This further application directory allows access to further sectors and hence execution of further applications.

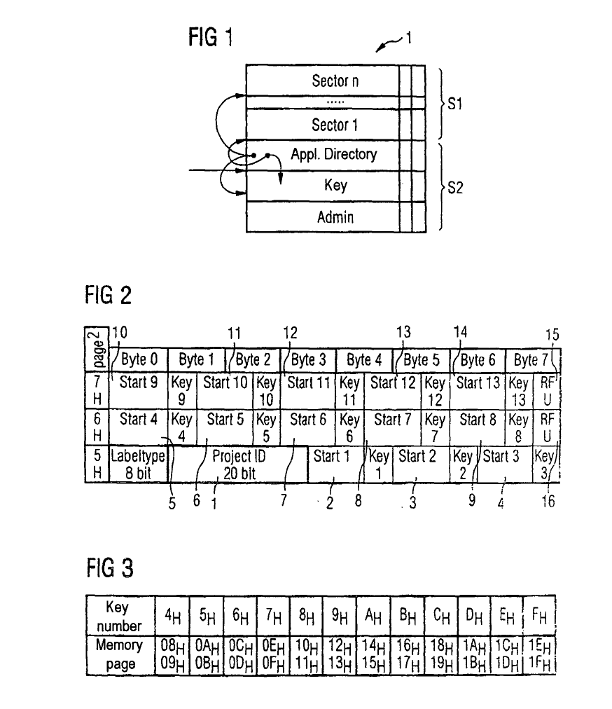

Now referring to the Figures, FIG. 1 shows the memory organization of a memory of a data storage medium (not shown here) in a data transmission system based on the invention. A memory area S1 of a memory 1 contains sectors 1 to n which store at least one application, for example for debiting a monetary value. A memory area S2, which has further sectors, stores an application directory, keys and also administration data. In this case, the application directory is stored as an 8-byte data block in memory pages of the memory area S2.

Within the data transmission system, it is necessary to set global default parameters which are known to the users, that is to say known to the read/write unit and to the data storage medium. The default parameters allow appropriate use of the system. By way of example, the following conventions can be agreed:

maximum number of sectors which can be used for applications,

number of keys per sector,

start address of the memory area or of the sector at which the application directory is stored,

a stipulated maximum size for the application directory, and

protection of the application directory by means of encryption.

A maximum number of useable sectors simultaneously implies a maximum number of keys which can be used for this data storage medium. In small-sized memories, the number of required keys per sector can be reduced to the number 1.

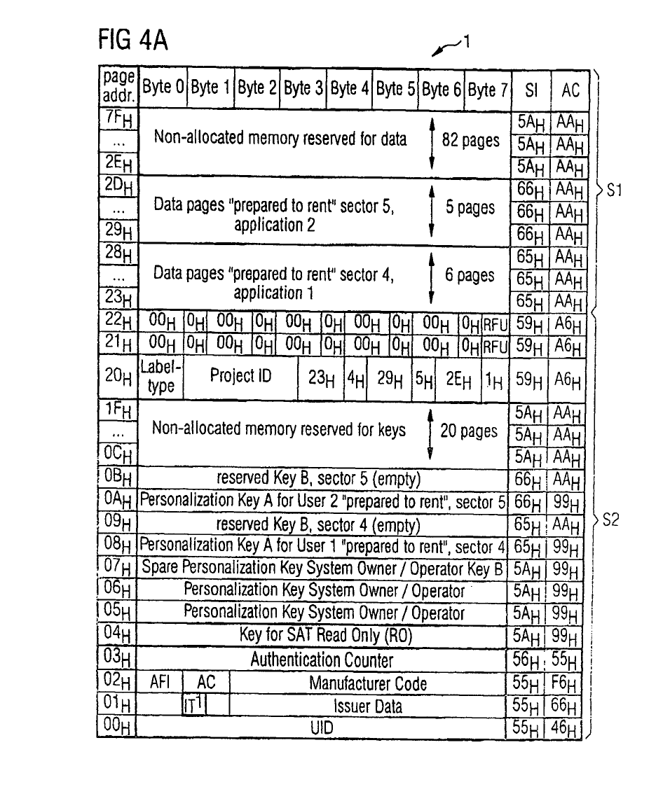

FIG. 2 shows a detailed exemplary embodiment of an application directory. The application directory is stored as an 8-byte data block on three memory pages 5H, 6H, 7H of the memory area S2 in the memory 1. The size of the data block and also the number of memory pages 5H, 6H, 7H limit the number of possible entries for logical application numbers. An attribute for identifying the application area of the data storage medium occupies the first 28 bits of the application directory in field 1. The first 8 bits identify the data storage medium itself, while the further 20 bits are used for identifying the application area. It is thus possible to make a unique association between the data storage medium and the permitted application area and the applications provided in this application area. A logical application number “1” occupies 8 bits in field 2 of the memory page 5H, and its associated key number occupies 4 bits. Further fields 3 to 14 contain the start addresses with associated key numbers for further logical applications. Fields 15 and 16 are not occupied and are withheld from future data.

In the application directory, the logical application numbers therefore have associated start addresses for sectors, that is to say a start address is stored as an entry in the application directory, with the logical application number being used as an index within the application directory, and the memory position of the entry corresponding to the logical application number and encoding it in this way.

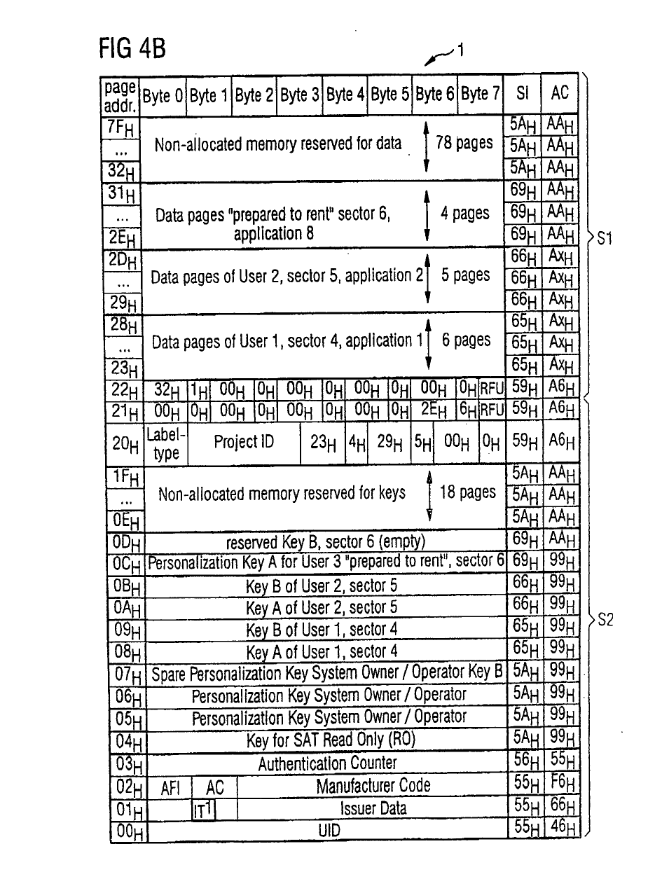

To execute an application associated with the sectors, the read/write unit reads the attribute in field 1 and verifies whether the data storage medium has an associated application area which has provision for execution of the desired application. If the result is positive, that is to say that the application can be executed and/or is stored in the memory of the data storage medium, the read/write unit uses a logical application number, corresponding to the executable application, in the application directory as an index in order to read a start address for a sector of the memory which stores the executable application. If the read/write unit indexes the logical application number “1” in field 2, for example, the encoding of the start address of the sector in which the application starts means that the memory position in field 2 refers directly to the start address. In addition, the key number associated with the logical application number is evaluated. To this end, a table which is described in FIG. 3 below is read.

FIG. 3 shows an exemplary embodiment of a table, stored in a memory in the read/write unit, with associations between key numbers and the memory position of a key in the memory of the data storage medium. Read and/or write operations in a protected sector require a key in order to be able to execute appropriate access operations. The fields in a first row of the table contain the logical key numbers. Fields in a second row of the table contain these numbers associated with the physical memory addresses at which the keys required for accessing the sectors are stored.

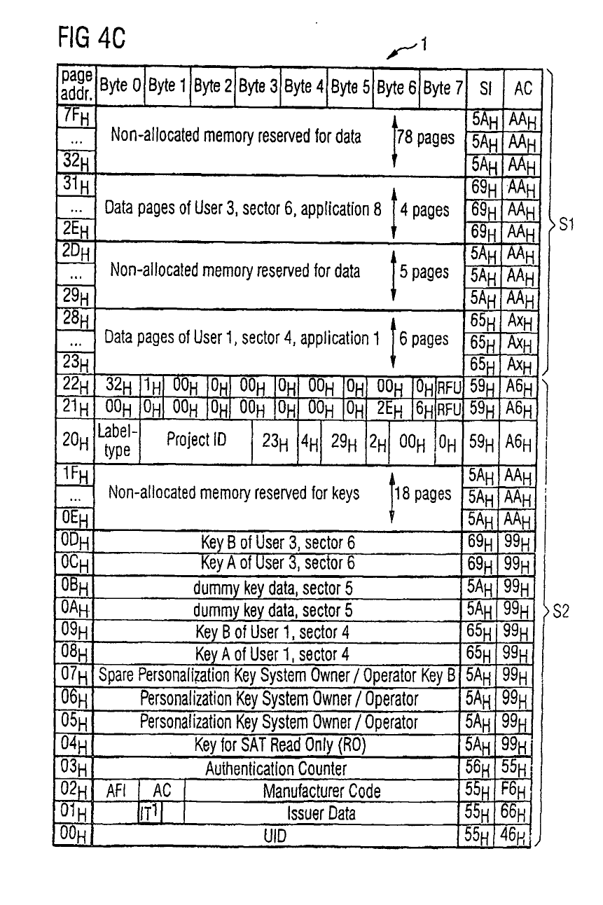

FIGS. 4a to 4c show a detailed illustration of the memory organization of the memory 1 which is shown in FIG. 1. In FIG. 4a, the memory area S2 stores keys in the memory pages 04 to 0B and stores the application directory in memory pages 20 to 22. Memory pages 0C to 1F are available for storing further keys. In the memory area S1, two sectors 4, 5 are associated with an application, the first application occupying six memory pages 23 to 28 in the first sector 4 and the second application occupying five memory pages 29 to 2D in the second sector 5. Further memory pages 2E to 7F are available for programming further applications. Field 2 of the application directory stores the start address of the first application and the key number required for accessing the sector as an entry so that this first entry in the application directory associates the logical application number “1” with the first application since this application number corresponds to the first memory position in the application directory. A similar situation applies to the second application, whose start address is stored in field 3, that is to say the second memory position, of the application directory as an entry so that the second application has the logical application number “2”. In line with the table in FIG. 3, the key number “4” associated with the first sector refers to the memory addresses 08 and 09, at which the keys required for accessing this first sector are stored. Similarly, the key number “5” associated with the logical application number “2” refers to the memory addresses 0A and 0B.

In FIG. 4b, a further application has been programmed into the memory 1 on memory pages 2E to 31 in a further sector. The further application has the logical application number “8”, which means that the entry comes at the eighth memory position in field 9 of the application directory and the entry refers to the start address 2E of the further sector, in which the application is stored.

In FIG. 4c, the application with the logical application number “2” has been erased, so that these memory pages are available for a future application.

The data transmission system according to one of the embodiments of the present invention allows flexible use of a memory integrated in a data storage medium, since memory areas can be assigned to new applications at any time. The data processing time is significantly shortened, since access to the applications is effected very quickly.

It will be appreciated by persons skilled in the art that the present invention is not limited to the embodiments described thus far with reference to the accompanying drawings; rather the present invention is limited only by the following claims

What is claimed is:

1. A data transmission system, for executing applications which are independent of one another and which are reciprocally protected by secret keys, comprising:
a data storage medium that has a segmented memory that stores an application directory that has an attribute for identifying an application area of the data storage medium and has a logical application number which is associated with an executable application and which is determinately specified by the attribute, wherein the logical application number is used as an index within the application directory; and
a read/write unit that stores the attribute and the logical application number of the application, the read/write unit being configured to execute the application by using the logical application number in the application directory for indexing and finding a start address for a sector of the memory which stores the executable application.

2. The data transmission system as claimed in claim 1, wherein additional logical application numbers are stored in the application directory, where the application numbers indicate start addresses for additional sectors.

3. The data transmission system as claimed in claim 1, wherein an executable application occupies a sector of stipulated memory size.

4. The data transmission system as claimed in claim 1, wherein the number of logical application numbers stored in the application directory corresponds to the number of executable applications.

5. The data transmission system as claimed in claim 1, wherein the application directory is stored as an 8-byte data block in memory pages of the memory.

6. The data transmission system as claimed in claim 1, wherein the attribute for identifying the application area of the data storage medium occupies the first bits of the application directory, with the less significant bits being used to identify the data storage medium and the more significant bits being used to identify the application area.

7. The data transmission system as claimed in claim 1, wherein the memory stores application-specific keys.

8. The data transmission system as claimed in claim 1, wherein the logical application number has an arbitrary associated key number specifying a stored key.

9. The data transmission system as claimed in claim 8, further including:
a table which is stored in a memory in the read/write unit, with the key number being associated with a physical memory address at which the application-specific key for executing the application is stored.

10. The data transmission system as claimed in claim 1, wherein the start address of the application in the sector is stored as an entry in the application directory, with the respective memory position of the entry corresponding to the logical application number.

11. The data transmission system as claimed in claim 10, wherein each entry occupies 8 bits and the key number occupies 4 bits in the application directory.

12. The data transmission system as claimed in claim 1, wherein the memory has a further application directory which can be activated by means of an entry in the application directory.

13. A method for operating a data transmission system, having a data storage medium with at least one executable application stored in a memory of the data storage medium and a stored application directory which stores an attribute for identifying an application area associated with the data storage medium and a logical application number associated with the executable application, and having a read/write unit which stores the attribute and the logical application number associated with the application, in which the read/write unit performs the following steps:
evaluating the attribute prior to execution of the application in order to establish whether the application area associated with the data storage medium has provision for execution of the application, and
if the result of the evaluation is positive, using a logical application number, corresponding to the executable application, in the application directory as an index in order to read a start address for a sector of the memory which stores the executable application.

14. The method as claimed in claim 13, wherein the application directory contains a key number associated with the logical application number, and the read/write unit reads the key number for the sector protected by a key against unauthorized access.

15. The method as claimed in claim 14, wherein the read/write unit is configured to perform the step of:
accessing a table which is stored in the memory and in which the key number has an associated physical memory address for the key required for accessing the sector.

16. The method as claimed in claim 13, wherein further start addresses that are stored in the application directory indicate further sectors, with the maximum number of executable applications corresponding to the maximum number of logical application numbers.

17. The method as claimed in claim 13, further comprising the steps of:
erasing the application from a sector; and
assigning the sector to a new programmable application within the memory.

18. A data transmission system, for executing applications which are independent of one another and which are reciprocally protected by secret keys, comprising:
a data storage medium that has a segmented memory that stores an application directory that has an attribute for identifying an application area of the data storage medium and has a logical application number which is associated with an executable application and which is determinately specified by the attribute, wherein the logical application number is used as an index within the application directory; and
a read/write unit that that is configured to evaluate the attribute prior to execution of the application in order to determine whether the application area has provision for execution of the application and if the result of the evaluation is positive, the read/write unit is configured to execute the application and index and locate a start address for a sector of the memory which stores the executable application.

19. The data transmission system as claimed in claim 18, wherein the read/write unit executes the application by using the logical application number in the application directory.

20. The data transmission system as claimed in claim 18, wherein the start address of the application is encoded in a sector by a respective memory position of the logical application number within the application directory.

21. The data transmission system as claimed in claim 18, wherein the application directory includes a table of start addresses for sectors that can have an associated application, the read/write unit being configured such that in order to access one application, one table entry in the application directory is read immediately on the basis of the logical application number without reading the entire application directory.
